(19) United States
(12) Patent Application Publication
(10) Pub. No.: US 2014/0349494 A1
(43) Pub. Date: Nov. 27, 2014

(54) ELECTRONIC DEVICE

(71) Applicants: Hon Hai Precision Industry Co., Ltd., New Taipei (TW); Hong Fu Jin Precision Industry (ShenZhen) Co., Ltd., Shenzhen (CN)

(72) Inventor: MENG-LIANG YANG, Shenzhen (CN)

(21) Appl. No.: 13/910,129

(22) Filed: Jun. 5, 2013

(30) Foreign Application Priority Data
May 27, 2013 (CN) 2013102004642

(51) Int. Cl. G06K 19/00

(52) U.S. Cl. CPC G06K 19/00
USPC 439/55

(57) ABSTRACT

The body of an electronic device defines a receiving space for the insertion of a memory card, and the connecting pins inside the receiving space are at two different heights. The lower first conductive pins and the more upstanding second conductive pins each include a fixing piece and a resilient piece. An angle between the fixing piece and the resilient piece of each pin is greater for the more upstanding second conductive pins than it is for the first conductive pins. A memory card is received between a pivoting cover and the first and second conductive pins and the conductive pins of the memory card firstly deform the second conductive pins and only then deform the first conductive pins, to press all the resilient pieces into electrical contact with their fixing pieces.

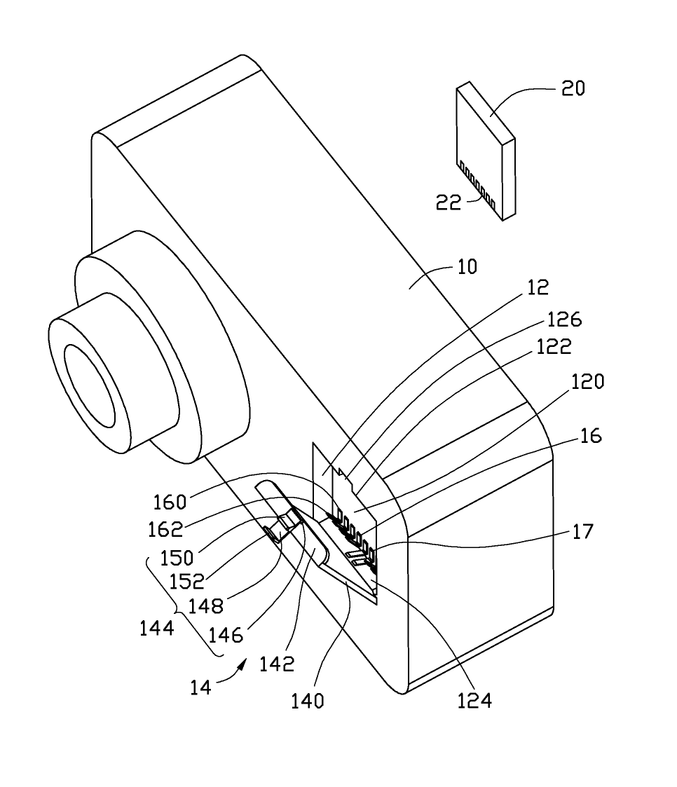

### BACKGROUND

1. Technical Field

The present disclosure relates to an electronic device, specifically relates to a camera.

2. Description of Related Art

Many electronic devices, such as cameras, define narrow slots to electrically receive memory cards. Since it is so easy to insert the memory card incorrectly into a slot, the user has to pull the memory card out of the slot, reverse the memory card, and then insert the memory card into the slot again. This is undesirable.

### BRIEF DESCRIPTION OF THE DRAWING

Many aspects of the present embodiments can be better understood with reference to the drawing. The components in the drawing are not necessarily drawn to scale, the emphasis instead being placed upon clearly illustrating the principles of the present embodiments.

The FIGURE is an isometric view of an embodiment of an electronic device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

Referring to the FIGURE, an embodiment of an electronic device, such as a camera, includes a body 10 and a memory card 20.

The body 10 defines a receiving space 12 and a recess 126 communicating with the receiving space 12. The receiving space 12 includes a bottom wall 120, and a first end wall 122 and a second end wall 124 perpendicularly connected to opposite ends of the bottom wall 120. The recess 126 is defined in the first end wall 122. A cover 14 is pivotably connected to the second end wall 124.

There is a plurality of first conductive pins 16 mounted to the bottom wall 120 adjacent to the second end wall 124 together with two second conductive pins 17 also mounted to the bottom wall 120 adjacent to the second end wall 124, and all the pins are arranged in a row parallel to the second end wall 124. Each of the first conductive pins 16 and the second conductive pins 17 includes a fixing piece 160 fixed to the bottom wall 120, and a resilient piece 162 slantingly extending upward and toward the cover 14 from an end of the fixing piece 160 adjacent to the second end wall 124. The angle between the fixing pieces 160 and resilient pieces 162 of the second conductive pins 17 is greater than the angle between the fixing pieces 160 and the resilient pieces 162 of the first conductive pins 16.

The cover 14 includes a plate 140 having a bottom end pivotably connected to the second end wall 124, an extension piece 142 perpendicularly extending toward the body 10 from a top end of the plate 124 opposite to the bottom end, and a locking member 144 mounted on the extension piece 142. The locking member 144 includes a connecting portion 146 perpendicularly extending up from the extension piece 142, an arm 148 perpendicularly extending away from the body 10 from a top end of the connecting portion 146, a protrusion 150 protruding from a top surface of the arm 148, and an operation piece 152 perpendicularly extending up from a distal end of the arm 148 opposite to the connecting portion 146. A surface of the protrusion 150 facing the connecting portion 146 is a slanted surface extending down and toward the connecting portion 146.

In use, the memory card 20 is received between the plate 140 and the first and second conductive pins 16 and 17, with conductive pins 22 of the memory card 20 facing the first and second conductive pins 16 and 17. The plate 140 is pivoted toward the body 10, to allow the conductive pins 22 first to make contact with and deform the resilient pieces 162 of the second conductive pins 17, and then to make contact with and deform the resilient pieces 162 of the first conductive pins 16, until all the resilient pieces 162 are in contact with their own fixing piece 160. Thereby, the body 10 is able to identify the memory card 20. At this time, the memory card 20 contacts the bottom wall 120, the extension piece 142 is received in the receiving space 12 and abuts against the first end wall 122 to achieve a dust-proof and water-proof environment. The protrusion 140 is engaged in the recess 126 and abuts against a top surface bounding the recess 126, thereby fixing the cover 14 and the memory 20 to the body 10.

In uninstalling the memory card 20, the arm 148 is pressed downward to disengage the protrusion 150 from the recess 126. The operation piece 152 is then operated to pivot the cover 14 away from the body 10, thereby exposing the memory card 20.

Because user can see the second and first conductive pins 17 and 16, the conductive pins 22 can be arranged to face the second and first conductive pins 17 and 16, before the memory card 20 is laid down in the receiving space 12, the memory card 20 will not be received in the body 10 the wrong way round.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. An electronic device, comprising:
a body defining a receiving space bounded by a bottom wall, and a first end wall and a second end wall at opposite ends of the bottom wall; the bottom wall forming a plurality of first conductive pins and a plurality of second conductive pins; the plurality of first conductive pins and the plurality of second conductive pins each comprising a fixing piece fixed to the bottom wall and a resilient piece slantingly connected to the fixing piece; an angle between the fixing piece and the resilient piece of each second conductive pin is greater than an angle between the fixing piece and the resilient piece of each first conductive pin;
a cover comprising a first end pivotably connected to the second end wall; and
a memory card forming a plurality of third conductive pins and received between the cover and the plurality of first and second conductive pins, with the plurality of third conductive pins facing the plurality of first and second conductive pins;
wherein, when the cover is pivoted toward the bottom wall, the plurality of third conductive pins of the memory card contact and deform the resilient pieces of the plurality of second conductive pins firstly, and contact and deform the resilient pieces of the plurality of first conductive pins secondly, until the resilient pieces contact the corresponding fixing pieces.

2. The electronic device of claim 1, wherein an extension piece perpendicularly extends from a second end of the cover opposite to the first end, to be received in the receiving space and abut against the first end wall.

3. The electronic device of claim 2, wherein the cover comprises a locking member, the locking member comprises a connecting portion perpendicularly connected to the extension piece, and an arm perpendicularly extending out from the connecting portion and away from the body, the protrusion protrudes from the arm.

4. The electronic device of claim 3, wherein a surface of the protrusion facing the connecting portion is a slanted surface slantingly extending down and toward the connecting portion.

5. The electronic device of claim 3, wherein an operation portion is perpendicularly connected to the arm.

6. The electronic device of claim 1, wherein the first end wall defines a recess communicating with the receiving space; a protrusion is formed a second end of the cover opposite to the first end, to detachably engage in the recess.

7. The electronic device of claim 1, wherein the electronic device is a camera.

8. An electronic device, comprising:
a body defining a receiving space bounded by a bottom wall, and a first end wall and a second end wall at opposite ends of the bottom wall; the bottom wall forming a plurality of first conductive pins and a plurality of second conductive pins; the plurality of first conductive pins and the plurality of second conductive pins each comprising a fixing piece fixed to the bottom wall and a resilient piece slantingly connected to the fixing piece; an angle between the fixing piece and the resilient piece of each second conductive pin is greater than an angle between the fixing piece and the resilient piece of each first conductive pin; and
a cover comprising a first end pivotably connected to the second end wall, wherein, when the cover is pivoted toward the bottom wall to install a memory card which comprises plurality of third conductive pins into the receiving space, the plurality of third conductive pins of the memory card contact and deform the resilient pieces of the plurality of second conductive pins firstly, and contact and deform the resilient pieces of the plurality of first conductive pins secondly, until the resilient pieces contact the corresponding fixing pieces.

9. The electronic device of claim 8, wherein an extension piece perpendicularly extends from a second end of the cover opposite to the first end, to be received in the receiving space and abut against the first end wall.

10. The electronic device of claim 9, wherein the cover comprises a locking member, the locking member comprises a connecting portion perpendicularly connected to the extension piece, and an arm perpendicularly extending out from the connecting portion and away from the body, the protrusion protrudes from the arm.

11. The electronic device of claim 10, wherein a surface of the protrusion facing the connecting portion is a slanted surface slantingly extending down and toward the connecting portion.

12. The electronic device of claim 10, wherein an operation portion is perpendicularly connected to the arm.

13. The electronic device of claim 8, wherein the first end wall defines a recess communicating with the receiving space; a protrusion is formed a second end of the cover opposite to the first end, to detachably engage in the recess.

14. The electronic device of claim 8, wherein the electronic device is a camera.
